(19) United States
(12) Patent Application Publication
(10) Pub. No.: US 2026/0073269 A1
(43) Pub. Date: Mar. 12, 2026

(54) OPTIMIZATION METHOD AND OPTIMIZATION DEVICE

(71) Applicant: TDK CORPORATION, Tokyo (JP)

(72) Inventor: Kaito ASAI, Tokyo (JP)

(73) Assignee: TDK CORPORATION, Tokyo (JP)

(21) Appl. No.: 19/108,288

(22) PCT Filed: Nov. 29, 2022
(86) PCT No.: PCT/JP2022/043942

§ 371 Date: Mar. 3, 2025

(51) Int. Cl. G06N 10/60

(52) U.S. Cl. CPC G06N 10/60

(57) ABSTRACT

This optimization method has a first regression process, a first optimization process, and a first determination process. The first regression process regresses a first function using a first training data group formed from combinations of an explanatory variable column and an objective variable. The first optimization process performs optimization of the first function and obtains a first explanatory variable column that is an optimal solution and a first predicted value obtained by substituting the first explanatory variable column into the first function. The first determination process determines whether a relationship between the first predicted value and a threshold value satisfies a condition. In a case in which the condition is not satisfied, a combination of the first explanatory variable column and the first predicted value is added to the first training data group as one of the combinations of the explanatory variable column and the objective variable.

### TECHNICAL FIELD

The present invention relates to an optimization method and an optimization device.

### BACKGROUND ART

Efforts have been made to obtain optimal solutions of combinatorial optimization problems using quantum annealing (for example, Patent Document 1). Optimization is a process of finding an optimal solution from a set of solutions.

### CITATION LIST

### Patent Document

Patent Document 1: Japanese Unexamined Patent Application, First Publication No. 2022-40049

### SUMMARY OF INVENTION

### Technical Problem

Various restriction conditions may be imposed on an optimization problem. By transforming restrictions into a penalty term and adding it to a cost function used in optimization calculation, an implausible explanatory variable column outputting a meaningless solution can be prevented from being output as an optimal solution. Meanwhile, it is not simple to appropriately apply restrictions to a cost function. First in transforming restrictions into a penalty term and assigning it to a cost function, it is difficult to determine how it is expressed as a penalty term. In addition, it is difficult to efficiently calculate an optimization problem using a cost function to which a penalty term has been added.

The present invention is in view of the situations described above, and an object thereof is to provide an optimization method and an optimization device enabling an efficient arithmetic operation by embedding restrictions in data used for regressing a function.

### Solution to Problem

In order to solve the problems described above, the present invention provides the following means.

An optimization method according to a first aspect has a first regression process, a first optimization process, and a first determination process. In the first regression process, a first function is regressed using a first training data group formed from combinations of an explanatory variable column and an objective variable. In the first optimization process, optimization of the first function is performed, and a first explanatory variable column that is an optimal solution of the first function and a first predicted value obtained by substituting the first explanatory variable column into the first function are obtained. In the first determination process, it is determined whether a relationship between the first predicted value and a threshold value satisfies a condition. In the first determination process, in a case in which the first predicted value does not satisfy the condition for the threshold value, a combination of the first explanatory variable column and the first predicted value is added to the first training data group as one of the combinations of the explanatory variable column and the objective variable.

In the first determination process of the optimization method according to the aspect described above, until it is determined that the first predicted value satisfies the condition for the threshold value, a loop including the first regression process, the first optimization process, and the first determination process may be repeated.

In the first determination process of the optimization method according to the aspect described above, in a case in which the first predicted value satisfies the condition for the threshold value, it may be determined whether the first explanatory variable column is executable on the basis of a restriction.

In the optimization method according to the aspect described above, in a case in which it is determined that the first explanatory variable column is inexecutable on the basis of the restriction, the first predicted value may be changed to a first correction value, and a combination of the first explanatory variable column and the first correction value may be added to the first training data group as one of the combinations of the explanatory variable column and the objective variable, the combination of the first explanatory variable column and the first predicted value may be removed from the first training data group, and the first training data group may be set as a second training data group.

In the optimization method according to the aspect described above, the first correction value may be obtained using the following relationship equation (1).

f′(s)=(1−r)×f(s)+r×t (1)

In the relationship equation (1), f′(s) is the first correction value, f(s) is the first predicted value, r is an update rate satisfying 0<r<1, and t is the threshold value.

The optimization method according to the aspect described above may further have a second regression process, a second optimization process, and a second determination process. In the second regression process, a second function is regressed using the second training data group. In the second optimization process, optimization of the second function is performed, and a second explanatory variable column that is an optimal solution of the second function and a second predicted value obtained by substituting the second explanatory variable column into the second function are obtained. In the second determination process, it is determined whether a relationship between the second predicted value and a threshold value satisfies a condition. In the second determination process, in a case in which the second predicted value does not satisfy the condition for the threshold value, a combination of the second explanatory variable column and the second predicted value is added to the second training data group as one of the combinations of the explanatory variable column and the objective variable. In the second determination process, in a case in which the second predicted value satisfies the condition for the threshold value, it is determined whether the second explanatory variable column is executable on the basis of the restriction.

In the second determination process of the optimization method according to the aspect described above, until it is determined that the second predicted value satisfies the condition for the threshold value, a loop including the second regression process, the second optimization process, and the second determination process may be repeated.

In the optimization method according to the aspect described above, in a case in which it is determined that the second explanatory variable column is inexecutable on the basis of the restriction, the second predicted value is changed to a second correction value. Then, a combination of the second explanatory variable column and the second correction value may be added to the second training data group as one of the combinations of the explanatory variable column and the objective variable, and the combination of the first explanatory variable column and the first correction value may be removed from the second training data group.

The optimization method according to the aspect described above may further have a third regression process, a substitution process, and a third determination process. In the third regression process, a third function is regressed using a third training data group acquired by excluding the combination of the first explanatory variable column and the first correction value from the second training data group in a case in which it is determined that the second explanatory variable column is executable on the basis of the restriction. In the substitution process, a substitution value is obtained by substituting the second explanatory variable column into the third function. In the third determination process, it is determined whether a relationship between the substation value and the threshold value satisfies a condition. In a case in which the substitution value does not satisfy the condition for the threshold value, a combination of the second explanatory variable column and the substitution value is added to the first training data group as one of the combinations of the explanatory variable column and the objective variable.

In the optimization method according to the aspect described above, the first regression process may be performed by a factorization machine.

In the optimization method according to the aspect described above, the first optimization process may be performed using quantum annealing.

In the optimization method according to the aspect described above, the first optimization process may be performed using classical annealing.

An optimization device according to a second aspect has a storage area, a regression calculation area, an optimization calculation area, and a determination area.

The storage area stores a training data group formed from combinations of an explanatory variable column and an objective variable. The regression calculation area regresses a function by performing regression analysis of the training data group. The optimization calculation area optimizes the function. The determination area determines whether or not the explanatory variable column and the predicted value obtained in the optimization calculation area satisfy a predetermined condition. In a case in which the determination area determines that the explanatory variable column and the predicted value do not satisfy the predetermined condition, the optimization device adds the explanatory variable column and the predicted value to the training data group of the storage area.

### Advantageous Effects of Invention

An optimization method and an optimization device according to the present invention can perform an efficient arithmetic operation by embedding restrictions in data used for regressing a function.

### BRIEF DESCRIPTION OF DRAWINGS

FIG. 1 is a flowchart of an optimization method according to the embodiment.

FIG. 2 is a schematic view describing a regression process.

FIG. 3 is a schematic view describing a first determination process.

FIG. 4 is a schematic view describing a first regression process and a first optimization process at the time of repeating a first loop process R1.

FIG. 5 is a schematic view describing a restriction checking process.

FIG. 6 is a schematic view describing a correction process.

FIG. 7 is a schematic view describing a regression process and an optimization process using a second training data group.

FIG. 8 is a schematic view describing a regression process and a substitution process.

FIG. 9 is a schematic view of an optimization device according to the embodiment.

### DESCRIPTION OF EMBODIMENT

Hereinafter, the embodiment will be described in detail by appropriately referring to the drawings. In the drawings used in the following description, in order to allow features of the embodiment to be easily understood, parts that form the features may be enlarged for convenience, and the dimensions, the ratios, and the like of constituent elements may be different from actual values. Materials, dimensions, and the like illustrated in the following description are examples, and the present invention is not limited thereto and can be appropriately changed and performed in a range not changing the gist thereof.

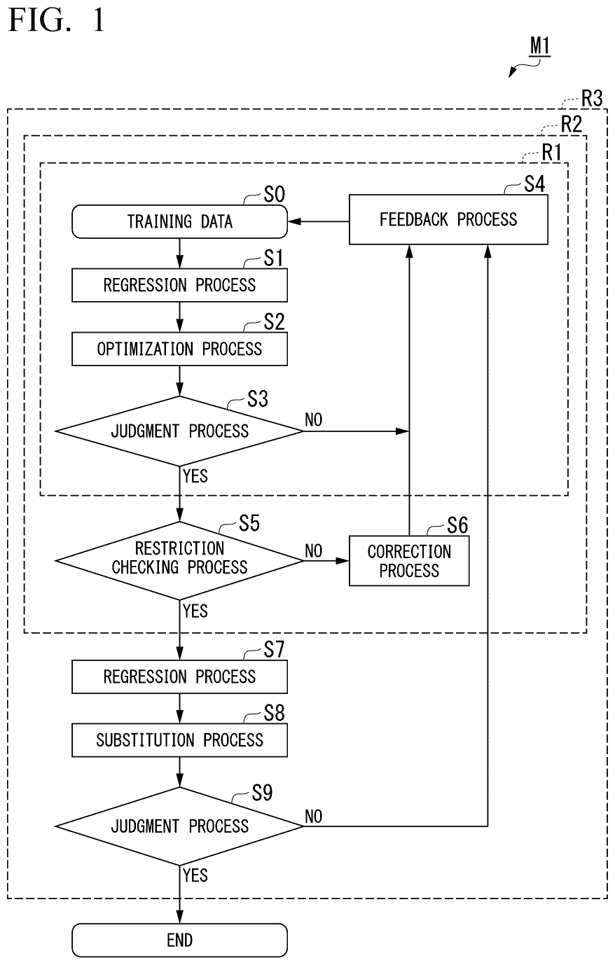

Optimization Method FIG. 1 is a flowchart of an optimization method according to the embodiment.

The optimization method M1 according to the embodiment, for example, has a first loop process R1, a second loop process R2, and a third loop process R3.

The optimization method M1, for example, has a training data determining process S0, a regression process S1, an optimization process S2, a determination process S3, a feedback process S4, a restriction checking process S5, a correction process S6, a regression process S7, a substitution process S8, and a determination process S9.

The optimization method M1 according to the embodiment is a black box optimization method. The black box optimization method is a method of searching for an optimal input on the basis of an output result for a certain input in a state in which a specific cost function desired to be maximized or minimized is unknown.

First, the first loop process R1 will be described. In the first loop process R1, for example, until a predetermined condition is satisfied, a loop including the training data determining process S0. the regression process S1, the optimization process S2, the determination process S3, and the feedback process S4 is repeated. It is determined in the determination process S3 whether or not a predetermined condition is satisfied.

In the training data determining process S0, a training data group formed from a combination of an explanatory variable column and an objective variable is determined. The training data group in the first loop process R1 will be referred to as a first training data group. The first training data group is slightly changed every time when the first loop process R1 is repeated.

The explanatory variable column is a collection of explanatory variables. Each of the explanatory variables, for example, is an option of an optimization problem. For example, an explanatory variable column is represented by (x, y, z). For example, in the case of a problem of obtaining a shortest means at the time of going from city A to city B, there are options such as a transportation means, a transit point, and duration of stay in each of the cities, and the like. In this case, for example, an option of the transportation means is assigned to an explanatory variable x, an option of the transit point is assigned to an explanatory variable y, and an option of the duration of stay is assigned to an explanatory variable z. Here, although a case in which the explanatory variable column is formed from three explanatory variables x, y, and z is illustrated, the number of explanatory variables configuring the explanatory variable column is arbitrary.

Each of the explanatory variables, for example, can be represented as a collection of binary variables. The explanatory variable can be represented, for example, using one-hot representation, binary representation, domain wall representation, or unary representation.

The objective variable is a variable representing a target to be optimized. For example, in the case of the problem of obtaining a shortest means at the time of going from the city A to the city B, the objective variable is a time taken at the time of selecting a specific option, or the like.

The training data is a collection of combinations representing a certain value that the objective variable has in the case of a specific explanatory variable column. First, for example, data based on facts obtained through experiments, inspections, and the like is used as initial first training data. The initial training data, for example, may be obtained from big data.

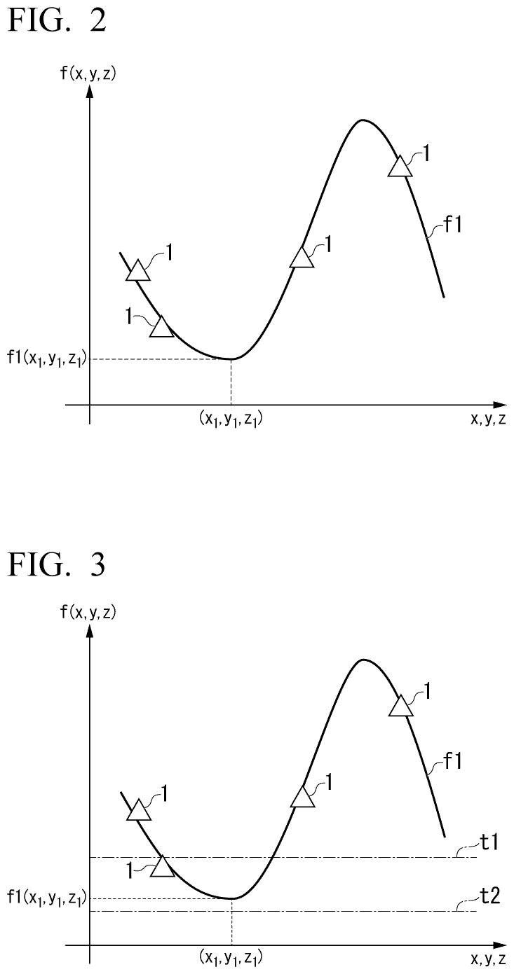

Next, the regression process S1 is performed using a first training data group. FIG. 2 is a schematic view describing the regression process S1. In the regression process S1, a function is regressed using the training data group. The regression represents estimation of a function to reproduce a relationship between an explanatory variable and an objective variable.

First, a first regression process is performed using the initial first training data group as the regression process S1. The first regression process is a regression process in the first loop process R1. FIG. 2 is a schematic view describing the first regression process and a first optimization process. In the first regression process of the first time, a first function f1 is regressed using the initial first training data group. Each piece of the training data 1 is represented using explanatory variables (x, y, z) and an objective variable (f(x, y, z)).

Next, the optimization process S2 is performed. In the optimization process S2, optimization of a function (cost function) acquired in the regression process S1 is performed. In the optimization, an explanatory variable column for which the cost function becomes a minimum or a maximum and becomes an optimal solution is obtained. In addition, in the optimization process S2, an explanatory variable column that is an optimal solution of the function and a predicted value obtained by substituting this explanatory variable column into the function are obtained.

For example, following the first regression process of the first time, the first optimization process of the first time is performed as the optimization process S2. The first optimization process is an optimization process in the first loop process R1. In the first optimization process of the first time, optimization of the first function f1 is performed. An explanatory variable column for which the first function becomes an optimal solution will be referred to as a first explanatory variable column. By substituting the first explanatory variable column into the first function, a first predicted value is obtained. For example, in a case in which the first explanatory variable column obtained in the first optimization process of the first time is (x₁, y₁, z₁), by substituting this into the first function f1 represented by f1(x, y, z), a first predicted value is obtained as f1(x₁, y₁, z₁).

Next, the determination process S3 is performed. In the determination process S3, it is determined whether a relationship between a predicted value and a threshold value satisfies a condition. The threshold value is arbitrarily set on the basis of the purpose. an arithmetic operation target, and the like. For example, in a case in which an optimal solution for which the cost function becomes a minimum is obtained in the optimization process S2, in the determination process S3, the condition is determined to be satisfied in a case in which the predicted value is less than the threshold value, and the condition is determined not to be satisfied in a case in which the predicted value is the threshold value or more. In addition, for example, in a case in which an optimal solution for which the cost function becomes a maximum is obtained in the optimization process S2, in the determination process S3, the condition is determined to be satisfied in a case in which the predicted value exceeds the threshold value, and the condition is determined not to be satisfied in a case in which the predicted value is the threshold value or less.

For example, following the first optimization process, a first determination process is performed as the determination process S3. FIG. 3 is a schematic view describing the first determination process. For example, in the first determination process of the first time, it is determined whether the relationship between the first predicted value f1(x₁, y₁, z₁) and the threshold value satisfies the condition.

For example, in the first determination process, the condition is determined to be satisfied in a case in which the first predicted value is less than a threshold value, and the condition is determined not to be satisfied in a case in which the first predicted value is the threshold value or more. For example, in a case in which a threshold value t1 illustrated in FIG. 3 is set as the threshold value, the first predicted value f1(x₁, y₁, z₁) is less than the threshold value t1, and the condition is determined to be satisfied in the first determination process. In contrast to this, for example, in a case in which a threshold value t2 illustrated in FIG. 3 is set as the threshold value, the first predicted value f1(x₁, y₁, z₁) is the threshold value t2 or more, and the condition is determined not to be satisfied in the first determination process.

Although a case in which an optimal solution for which the first function f1 becomes a minimum is obtained is illustrated in FIG. 3, in a case in which an optimal solution for which the first function f1 becomes a maximum is obtained, in the first determination process, the condition may be determined to be satisfied in a case in which the predicted value exceeds a threshold value, and the condition may be determined not to be satisfied in a case in which the predicted value is the threshold value or less.

In a case in which the predicted value does not satisfy the condition for the threshold value, the process proceeds to the feedback process S4. In the first loop process R1, a first feedback process is performed as the feedback process S4. In the first feedback process, a process of adding a result obtained through an arithmetic operation to the first training data group is performed. For example, in FIG. 3, in a case in which the threshold value is the threshold value t2, the condition is determined not to be satisfied in the first determination process, and the first feedback process is performed. The first feedback process is a feedback process in the first loop process R1.

In the first feedback process of the first time, a combination of a first explanatory variable column (x₁, y₁, z₁) and a first predicted value f1(x₁, y₁, z₁) is added to the first training data group as one of a combination of an explanatory variable column and an objective variable. Here, in the first feedback process of the first time, the first explanatory variable column and the first predicted value that are estimated values obtained in the first optimization process are directly added to the first training data group. In other words, estimated values output as operation results are added to the initial first training data having high reliability based on facts. Although there are cases in which an estimated value output in an optimization operation is actually measured and is added to training data as an actually-measured value, direct addition of an estimated value of an arithmetic operation to training data is not generally performed. However, by performing this process, randomness is applied to regression, and regressive analysis of a function is efficiently performed.

The first loop process R1 is performed until a predicted value obtained in the optimization process S2 satisfies the condition for the threshold value.

In a case in which the predicted value does not satisfy the condition for the threshold value, next to the feedback process S4, the training data determining process S0 is performed. In a case in which the first loop process R1 is performed, the first training data group is rewritten.

For example, the first training data group is acquired by adding a combination of the first explanatory variable column and the first predicted value f1 to the initial training data group. In a case in which the first loop process R1 is repeated two or more times, the first training data group is acquired by adding a combination of the first explanatory variable column and the first predicted value obtained in the optimization process S2 of the previous loop to the training data group used for regressing the first function in the previous loop. Every time the first loop process R1 is performed, a combination of the first explanatory variable column and the first predicted value obtained in the optimization process S2 of the previous loop is added to the first training data group.

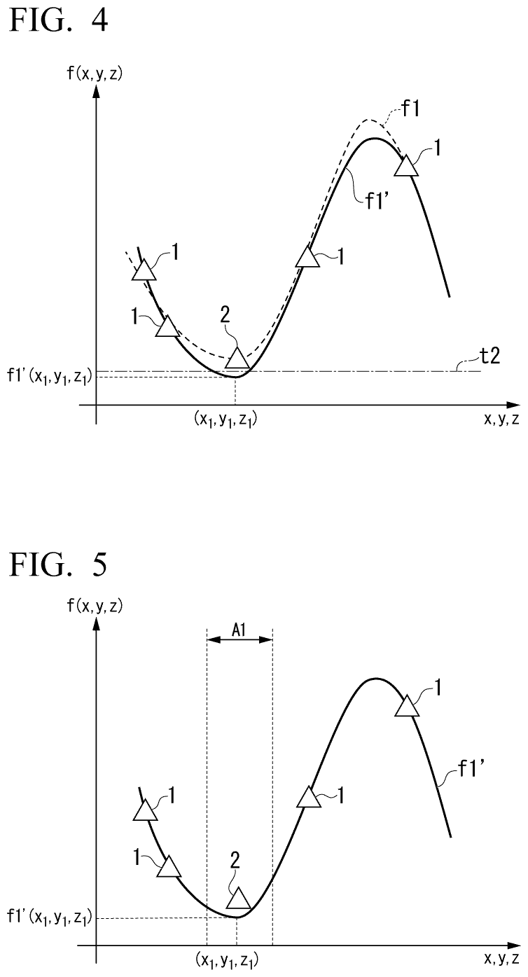

Next, again, the regression process S1 is performed again using the rewritten first training data group. FIG. 4 is a schematic view describing a first regression process and a first optimization process at the time of repeating the first loop process R1. In the regression process performed again, a first function f1′ is regressed using the first training data group. In many cases, the first function f1′ does not coincide with the first function f1. The reason for this is that, training data 2 formed from the first explanatory variable column and the first predicted value is added in the first training data group used for regressing the first function f1′, and the first training data group does not coincide with the first training data group before performance of the loop. Every time the first loop process R1 is repeated, the first function obtained in the regression process S1 is changed. The reason for this is that, every time the first loop process R1 is repeated, the first training data group can be rewritten.

Next, the optimization process S2 is performed again. For example, in the optimization process S2, optimization of the first function f1′ is performed. By optimizing the first function f1′, the first explanatory variable column (x₁, y₁, z₁) is newly obtained. In addition, by substituting this first explanatory variable column (x₁, y₁, z₁) into the first function f1′, a first predicted value f1′(x₁, y₁, z₁) is obtained. Every time the first loop process R1 is repeated, the first explanatory variable column and the first predicted value are changed. The reason for this is that, every time the first loop process R1 is repeated, the first function is changed.

Next, the determination process S3 is performed again. In the determination process S3, for example, it is determined whether a relationship between the first predicted value f1′(x₁, y₁, z₁) and the threshold value satisfies the condition.

For example, in a case in which the threshold value is the threshold value t2 represented in FIG. 4, the first predicted value f1′(x₁, y, z₁) is less than the threshold value t2, and it is determined that the condition is satisfied in the determination process S3. Although the condition that the first predicted value f1(x₁, y₁, z₁) obtained in FIG. 3 is less than the threshold value t2 is not satisfied, the condition that the first predicted value f1′(x₁, y₁, z₁) obtained in FIG. 4 is less than the threshold value t2 is satisfied. By repeating the first loop process R1, the relationship between the predicted value and the threshold value satisfies the condition, and the first loop process R1 ends.

In the first loop process R1, when the predicted value obtained in the optimization process S2 satisfies the condition for the threshold value, the process reaches the restriction checking process S5.

The restriction checking process S5 is performed in a case in which it is determined that the predicted value satisfies the condition for the threshold value in the determination process S3. In the restriction checking process S5, it is determined whether an explanatory variable column obtained in the optimization process S2 as the optimal solution is executable on the basis of the restriction.

A restriction may be imposed on an explanatory variable. For example, there is a case in which a restriction that an option of a vehicle cannot be selected is imposed at the time of going from the city A to the city B. In this case, a restriction that an option x₁ cannot be selected is imposed on the explanatory variable x.

FIG. 5 is a schematic view describing the restriction checking process S5 according to the embodiment. FIG. 5 is a schematic view describing a first restriction checking process. In the first restriction checking process, it is determined whether a first explanatory variable column is executable on the basis of a restriction.

In a case in which a restriction is imposed on selection of an explanatory variable, a selection impossible area A1 is present in the explanatory variable column. In a case the first explanatory variable column (x₁, y₁, z₁) is within the selection impossible area A1, this explanatory variable column cannot be selected. In the first restriction checking process, it is determined whether or not the first explanatory variable column (x₁, y₁, z₁) is within the selection impossible area A1. In addition, in a case in which the first loop process R1 is not performed, and it is determined that the relationship between the first predicted value f1(x₁, y₁, z₁) and the threshold value satisfies the condition in the determination process S3 of the first time, it is determined whether or not the first predicted value f1(x₁, y₁, z₁) is within the selection impossible area A1.

In FIG. 5, the first explanatory variable column (x₁, y₁, z₁) obtained as an optimal solution of the first function f1′ is within the selection impossible area A1. Even though the first explanatory variable column (x₁, y₁, z₁) obtained as an optimal solution in the first optimization process and the first predicted value f1′(x₁, y₁, z₁) satisfy the condition for the threshold value, a result acquired using these cannot be performed (selected) in reality.

In the restriction checking process S5, in a case in which it is determined that the explanatory variable column obtained as the optimal solution in the optimization process S2 is inexecutable on the basis of the restriction, the correction process S6 is performed. In the correction process S6, the predicted value is changed to a correction value.

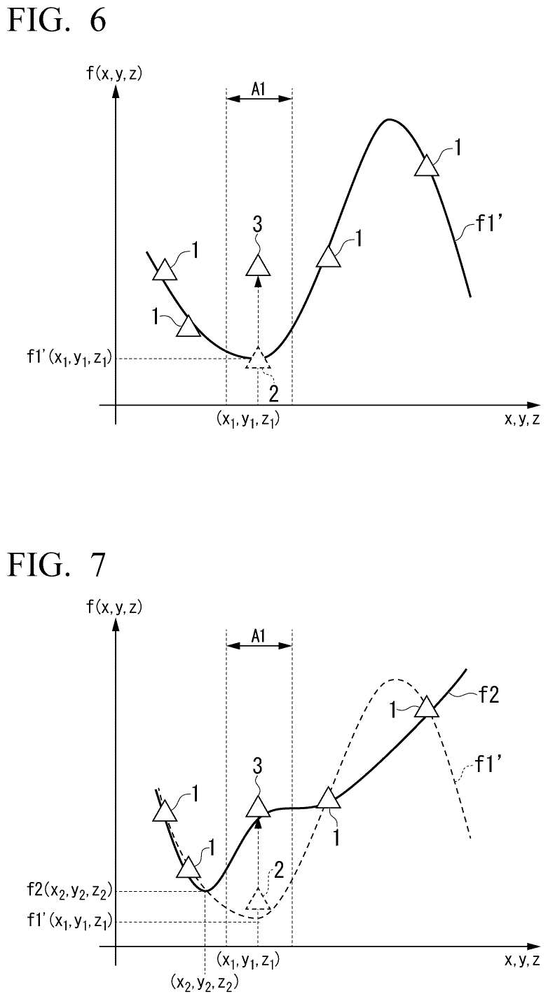

FIG. 6 is a schematic view describing the correction process S6 according to the embodiment. FIG. 6 is a schematic view describing the correction process S6. In the correction process S6, the first predicted value is changed to a first correction value. For example, as illustrated in FIG. 6, in a case in which a minimum value is obtained as an optimal solution, the first predicted value is rounded up to be set as the first correction value. To the contrary, in a case in which a maximum value is obtained as an optimal solution, the first predicted value is rounded down to be set as the first correction value.

In the correction process S6, training data 2 formed from the first explanatory variable column and the first predicted value is changed to training data 3 formed from the first explanatory variable column and the first correction value. The first correction value illustrated in FIG. 6 is a value acquired by adding a numerical value to the first predicted value and rounding up the result thereof.

For example, the first correction value is obtained using the following relationship equation (1).

$${f}^{′} ( s ) = ( 1 - r ) \times f ( s ) + r \times t \qquad ( 1 )$$

In the relationship equation (1), f′(s) is the first correction value, f(s) is the first predicted value, and r is an update rate satisfying 0<r<1. f(s), for example, is f(x₁, y₁, z₁).

Following the correction process S6, the feedback process S4 is performed. The feedback process S4 performed after the correction process S6 will be referred to as a second feedback process. In the second feedback process, the training data 2 formed from the combination of the first explanatory variable column and the first predicted value is excluded from the first training data group, and the training data 3 formed from the combination of the first explanatory variable column and the first correction value is added to the first training data group. By performing the second feedback process, the first training data group becomes the second training data group.

Next, by using the second training data group, the training data determining process S0, the regression process S1, the optimization process S2, and the determination process S3 are sequentially performed. FIG. 7 is a schematic view describing the regression process S1 and the optimization process S2 using the second training data group.

In the regression process S1, a second regression process is performed using the second training data group. In the second regression process, a second function f2 is regressed using the second training data group. The second regression process can be performed similar to the first regression process except that the first training data group is changed to the second training data group including the first correction value.

In the optimization process S2, by optimizing the second function f1, the second optimization process is performed. The second optimization process can be performed similar to the first optimization process except that a function to be optimized is changed from the first function to the second function. In the second optimization process, a second explanatory variable column (x₂, y₂, z₂) that is an optimal solution of the second function f2 and a second predicted value f2(x₂, y₂, z₂) obtained by substituting the second explanatory variable column (x₂, y₂, z₂) into the second function f2 are obtained.

In the second training data group, the first predicted value included in the selection impossible area A1 is changed to the first correction value, and thus the probability of the second explanatory variable column entering the inside of the selection impossible area A1 is lower than that of a case in which the first function f1′ is optimized.

In the determination process S3, a second determination process is performed. In the second determination process, it is determined whether the relationship between a second predicted value f2(x₂, y₂, z₂) and the threshold value satisfies the condition. The second determination process can be performed similar to the first determination process except that the first predicted value is changed to the second predicted value.

In the second determination process, in a case in which the second predicted value does not satisfy the condition for the threshold value, the feedback process S4 is performed. In the feedback process S4 after the second determination process, a combination of the second explanatory variable column and the second predicted value is added to the second training data group as one of combinations of an explanatory variable column and an objective variable. Then, by using the rewritten second training data group, the first loop process R1 including the second regression process, the second optimization process, and the second determination process is performed again. The first loop process R1 is performed until the second predicted value obtained in the optimization process S2 satisfies the condition for the threshold value.

In the second determination process, in a case in which the second predicted value satisfies the condition for the threshold value, the restriction checking process S5 is performed. The restriction checking process S5 performed after the second determination process will be referred to as a second restriction checking process. In the second restriction checking process, it is determined whether the second explanatory variable column is executable on the basis of the restriction. The second restriction checking process can be performed similar to the first restriction checking process except that the determination target is changed from the first explanatory variable column to the second explanatory variable column.

In the second restriction checking process, in a case in which it is determined that the second explanatory variable column is inexecutable on the basis of the restriction, the second predicted value is converted into a second correction value in the correction process S6. The process of converting the second predicted value into the second correction value will be referred to as a second correction process. A method for converting the second predicted value into the second correction value is similar to the method for converting the first predicted value into the first correction value.

Next, the feedback process S4 is performed. In the feedback process S4, the combination of the second explanatory variable column and the second correction value described above is added to the second training data group as one of combinations of an explanatory variable column and an objective variable, and the combination of the first explanatory variable column and the first correction value is removed from the second training data group. This process will be referred to as a third feedback process.

Then, by using the rewritten second training data group, the second loop process R2 including the second regression process, the second optimization process, the second determination process, the second restriction checking process, the second correction process, and the third feedback process is performed again. The second loop process R2 is performed until it is determined that the second explanatory variable column is executable on the basis of the restriction in the second restriction checking process.

In the second loop process R2, in a case in which it is determined that the optimized explanatory variable column is executable on the basis of the restriction in the restriction checking process S5, the second loop process R2 ends. When the second loop process R2 ends, the regression process S7, the substitution process S8, and the determination process S9 are performed. In a case in which the process reaches the regression process S7 not through the second loop process R2, the regression process S7, the substitution process S8, and the determination process S9 can be omitted.

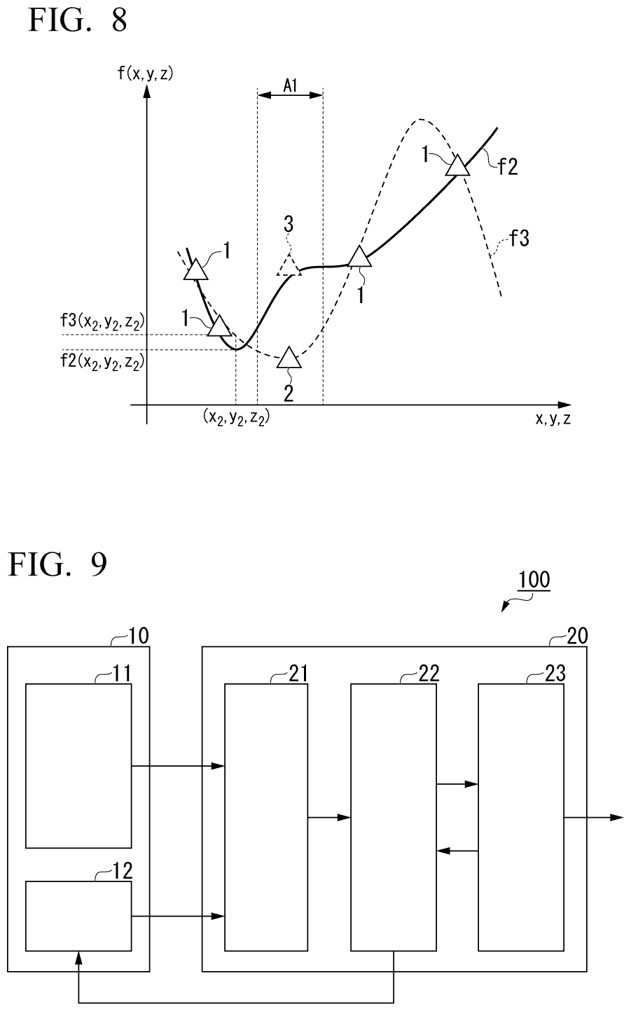

In the regression process S7, for example, a third function f3 is regressed using the third training data group acquired by excluding the combination of the first explanatory variable column and the first correction value from the second training data group. The third training data group may be acquired by excluding the combination of the first explanatory variable column and the first correction value from the second training data group and adding the combination of the first explanatory variable column and the first predicted value thereto. FIG. 8 is a schematic view describing the regression process S7 and the substitution process S8.

In the substitution process S8, by substituting the second explanatory variable column acquired when being executable is determined in the second restriction checking process into the third function, a substitution value is obtained. By substituting the second explanatory variable column into the third function obtained from the third training data group acquired by excluding an intentionally-corrected correction value from the second training data group, accurate prediction of an optimal value problem can be performed.

For example, as illustrated in FIG. 8, by substituting the second explanatory variable column (x₂, y₂, z₂) into the third function f3, f3(x₃, y₃, z₃), which is a substitution value, is obtained. In addition, for example, in a case in which the second loop process R2 is not performed after the first loop process R1 is performed, by substituting the second explanatory variable column (x₂, y₂, z₂) into the first function f1, f1(x₂, y₂, z₂), which is a substitution value, may be obtained.

Next, in the determination process S9, it is determined whether the relationship between the substitution value and the threshold value satisfies the condition. The third determination process is one example of the determination process S9.

In the determination process S9, it is determined that the condition is satisfied in a case in which the substitution value is less than the threshold value, and it is determined that the condition is not satisfied in a case in which the substitution value is the threshold value or more. In the determination process S9. it may be determined that the condition is satisfied in a case in which the substitution value exceeds the threshold value, and it may be determined that the condition is not satisfied in a case in which the substitution value is the threshold value or less.

In a case in which the substitution value does not satisfy the condition for the threshold value, the process proceeds to the feedback process S4. In the feedback process S4, a fourth feedback process S4 is performed. The fourth feedback process S4 is a feedback process in the third loop process R3. In the feedback process S4, the process of adding the second explanatory variable obtained in the optimization process S2 and the substitution value to the training data group is performed.

Then, until the substitution value satisfies the condition for the threshold value, the third loop process R3 is repeated.

When the substitution value satisfies the condition for the threshold value, the optimization arithmetic operation ends.

The regression process S1 in the optimization method M1 may be performed by a factorization machine. The factorization machine is one type of machine learning model.

The optimization process S2 in the optimization method M1 may be performed using either quantum annealing or classical annealing.

Quantum annealing is an algorithm that obtains a lowest energy state (a ground state) in accordance with a computation model. For example, an Ising model, a QUBO, and the like are computation models that are applicable to quantum annealing.

The Ising model is a model that predicts a state that becomes stable as a whole in a case in which multiple elements interact with each other, and a coercive force is applied to each of the elements. QUBO (Quadratic Unconstrained Binary Optimization) is a computation model that can be equivalently converted into an Ising model. While each bit b is represented using a variable with a binary value of +1 or −1 in the Ising model, in QUBO, each bit b is represented using a variable with a binary value of 0 or 1.

Classical annealing is an algorithm. Simulated annealing is one type of classical annealing. For example, a coherent Ising machine (NTI), a simulated bifurcation machine (Toshiba), a digital annealer (Fujitsu), a CMOS annealer (Hitachi), Amplify AE (Fixstar Amplify), and the like are devices that execute the classical annealing.

As described above, in the optimization method M1 according to the embodiment, an estimated value output as a result of an arithmetic operation is added to initial first training data having high reliability based on facts. Although there are cases in which an estimated value output in an optimization arithmetic operation is actually measured and is added to training data as an actually-measured value, direct addition of an estimated value of an arithmetic operation to training data is not generally performed, and, by performing this process, randomness is applied to regression, whereby regression analysis of a function becomes efficient.

In addition, in the optimization method M1 according to the embodiment, by determining whether or not an explanatory variable enters the selection impossible area A1, a restriction can be imbedded in data for regressing a cost function for obtaining an optimization problem. For this reason, there is no need to review how a penalty term assigned to a cost function is represented.

### Optimization Device

An optimization device according to the embodiment is a device used for executing the optimization method M1 described above. FIG. 9 is a schematic view of the optimization device 100 according to the embodiment.

The optimization device 100 has a storage area 10 and a calculation area 20. The storage area 10 has a first storage area 11 and a second storage area 12. The calculation area 20 has a regression calculation area 21. an optimization calculation area 22, and a determination area 23.

The storage area 10 is an area in which a training data group is stored. The storage area 10, for example, may be a register included inside a microprocessor or may be a server installed outside.

The first storage area 11 stores an original training data group. The original training data is a collection of combinations that indicate the solution to the objective variable in the case of a specific explanatory variable column and, for example, is data obtained through experiments, surveys, and the like or data acquired from big data.

The second storage area 12 stores an explanatory variable column and a predicted value obtained in the optimization process S2, a correction value obtained in the correction process S6, and a substitution value obtained in the substitution process S8.

The calculation area 20 is a general-purpose information-processing device, an annealing machine, or the like. For example, machines such as a personal computer, a supercomputer, and a microcomputer are examples of the general-purpose information-processing device. The calculation area 20 performs a process on the basis of a program.

The regression calculation area 21 obtains a cost function on the basis of a training data group. The regression calculation area 21 performs the regression process S1 and the regression process S7 described above.

The optimization calculation area 22 performs optimization of a cost function. The optimization calculation area 22 performs the optimization process S2 described above. An explanatory variable column that becomes an optimal solution and a predicted value obtained in the optimization calculation area 22 are transmitted to the second storage area 12. In addition, the optimization calculation area 22 may perform the correction process S6 and the substitution process S8. The correction value obtained in the correction process S6 and the substitution value obtained in the substitution process S8 are transmitted to the second storage area 12.

The determination area 23 determines whether or not the explanatory variable column and the predicted value or the substitution value obtained by the optimization calculation area satisfy a predetermined condition. The determination area 23, for example, has an area performing the determination processes S3 and S9 and an area performing the restriction checking process S5.

In a case in which the determination area 23 determines that the explanatory variable column and the predicted value do not satisfy the predetermined condition, the optimization device 100 instructs the first training data group stored in the first storage area 11 of the storage area 10 to add the explanatory variable column and the predicted value stored in the second storage area 12. Then, the optimization device 100 transmits data from the first storage area 11 and the second storage area 12 to the optimization calculation area 22.

In a case in which the determination area 23 determines that the explanatory variable column and the predicted value do not satisfy a predetermined condition, the optimization device 100 outputs a result thereof.

As described above, although embodiments of the present invention have been described in detail with reference to the drawings, configurations of each embodiment and a combination thereof are merely examples, and additions, omissions, substitutions, and other changes of the configurations can be performed within a range not departing from the gist of the present invention.

### REFERENCE SIGNS LIST

1, 2, 3 Training data
10 Storage area
11 First storage area
12 Second storage area
20 Calculation area
21 Regression calculation area
22 Optimization calculation area
23 Determination area
100 Optimization device
A1 Selection impossible area
M1 Optimization method
R1 First loop process
R2 Second loop process
R3 Third loop process
S0 Training data determining process
S1, S7 Regression process
S2 Optimization process
S3 Determination process
S4 Feedback process
S5 Restriction checking process
S6 Correction process
S8 Substitution process
S9 Determination process
t1, t2′Threshold value

1. An optimization method comprising:
a first regression process of regressing a first function using a first training data group formed from combinations of an explanatory variable column and an objective variable;
a first optimization process of performing optimization of the first function and obtaining a first explanatory variable column that is an optimal solution of the first function and a first predicted value obtained by substituting the first explanatory variable column into the first function; and
a first determination process of determining whether a relationship between the first predicted value and a threshold value satisfies a condition,
wherein, in the first determination process, in a case in which the first predicted value does not satisfy the condition for the threshold value, a combination of the first explanatory variable column and the first predicted value is added to the first training data group as one of the combinations of the explanatory variable column and the objective variable.

2. The optimization method according to claim 1, wherein, in the first determination process, until it is determined that the first predicted value satisfies the condition for the threshold value, a loop including the first regression process, the first optimization process, and the first determination process is repeated.

3. The optimization method according to claim 1, wherein, in the first determination process, in a case in which the first predicted value satisfies the condition for the threshold value, it is determined whether the first explanatory variable column is executable on the basis of a restriction.

4. The optimization method according to claim 3,
wherein, in a case in which it is determined that the first explanatory variable column is inexecutable on the basis of the restriction, the first predicted value is changed to a first correction value, and
wherein a combination of the first explanatory variable column and the first correction value is added to the first training data group as one of the combinations of the explanatory variable column and the objective variable, the combination of the first explanatory variable column and the first predicted value is removed from the first training data group, and the first training data group is set as a second training data group.

5. The optimization method according to claim 4, wherein the first correction value is obtained using the following relationship equation (1).
$${f}^{′} ( s ) = ( 1 - r ) \times f ( s ) + r \times t \qquad ( 1 )$$
In the relationship equation (1), f′(s) is the first correction value, f(s) is the first predicted value, r is an update rate satisfying 0<r<1, and t is the threshold value.

6. The optimization method according to claim 4, further comprising:
a second regression process of regressing a second function using the second training data group;
a second optimization process of performing optimization of the second function and obtaining a second explanatory variable column that is an optimal solution of the second function and a second predicted value obtained by substituting the second explanatory variable column into the second function; and
a second determination process of determining whether a relationship between the second predicted value and a threshold value satisfies a condition,
wherein, in the second determination process, in a case in which the second predicted value does not satisfy the condition for the threshold value, a combination of the second explanatory variable column and the second predicted value is added to the second training data group as one of the combinations of the explanatory variable column and the objective variable, and
wherein, in the second determination process, in a case in which the second predicted value satisfies the condition for the threshold value, it is determined whether the second explanatory variable column is executable on the basis of the restriction.

7. The optimization method according to claim 6, wherein, in the second determination process, until it is determined that the second predicted value satisfies the condition for the threshold value, a loop including the second regression process, the second optimization process, and the second determination process is repeated.

8. The optimization method according to claim 6,
wherein, in a case in which it is determined that the second explanatory variable column is inexecutable on the basis of the restriction, the second predicted value is changed to a second correction value, and
wherein a combination of the second explanatory variable column and the second correction value is added to the second training data group as one of the combinations of the explanatory variable column and the objective variable, and the combination of the first explanatory variable column and the first correction value is removed from the second training data group.

9. The optimization method according to claim 6, further comprising:
a third regression process of regressing a third function using a third training data group acquired by excluding the combination of the first explanatory variable column and the first correction value from the second training data group in a case in which it is determined that the second explanatory variable column is executable on the basis of the restriction;
a substitution process of obtaining a substitution value by substituting the second explanatory variable column into the third function; and
a third determination process of determining whether a relationship between the substation value and the threshold value satisfies a condition;
wherein, in a case in which the substitution value does not satisfy the condition for the threshold value, a combination of the second explanatory variable column and the substitution value is added to the first training data group as one of the combinations of the explanatory variable column and the objective variable.

10. The optimization method according to claim 1, wherein the first regression process is performed by a factorization machine.

11. The optimization method according to claim 1, wherein the first optimization process is performed using quantum annealing.

12. The optimization method according to claim 1, wherein the first optimization process is performed using classical annealing.

13. An optimization device comprising:
a storage area storing a training data group formed from combinations of an explanatory variable column and an objective variable;
a regression calculation area regressing a function by performing regression analysis of the training data group;
an optimization calculation area optimizing the function; and
a determination area determining whether or not the explanatory variable column and the predicted value obtained in the optimization calculation area satisfy a predetermined condition,
wherein, in a case in which the determination area determines that the explanatory variable column and the predicted value do not satisfy the predetermined condition, the explanatory variable column and the predicted value are added to the training data group of the storage area.
